(19) United States
(12) Patent Application Publication
(10) Pub. No.: US 2002/0073602 A1
(43) Pub. Date: Jun. 20, 2002

(54) Line holder

(76) Inventor: Joseph Neyman, Annapolis, MD (US)

Correspondence Address: GREENBERG & LIEBERMAN, 314 PHILADELPHIA AVE., TAKOMA PARK, MD, 20912, US

(21) Appl. No.: 09/683,354

(22) Filed: Dec. 18, 2001

Related U.S. Application Data
(60) Provisional application No. 60/255,421, filed on Dec. 15, 2000.

(51) Int. Cl. A01K 87/00

(52) U.S. Cl. 43/25.2

(57) ABSTRACT

A leader wrap apparatus is presented for use in the sport of trolling fishing. It has two pairs of legs with fasteners situated on a first plane. Under the first plane are two sets of bars and connecting to the second plane. The leader wrap apparatus is constructed of a durable plastic, and is manufactured in bright colors to allow a user to easily view the leader wrap apparatus if it should come detached from a fishing pole during use. The leader wrap communicates with a fishing pole through use of the legs and fasteners. The bars are constructed to create a hollow section between the first and second sets of bars for holding lures or hooks, which are attached to the fishing line. The leader wrap apparatus allows the user to fish with a leader line as in trolling without entanglement of the two lines.

### CROSS REFERENCE TO RELATED APPLICATIONS

Priority is hereby claimed to provisional application No. 60/255,421 filed Dec. 15, 2000.

### BACKGROUND OF INVENTION

The sport of fishing has grown in popularity in fresh, sea, and deep-sea areas over the past few years. Many people choose to spend their vacation time fishing and shrimping at coastal areas. Fishing poles have made great advancements in weight, and flexibility to support the growing demands of fishing as a sport.

Trolling in particular creates an additional problem for users due to the additional lures or live bait. The traditional method of trolling includes swivels, snap swivels and possibly lures dispersed along the line every 10 to 30 feet. These devices create an obstacle upon reel in of the line, as the user cannot reel the line onto the reel as usual, and must wrap the line in a different manner than on other types of fishing.

U.S. Pat. No. 4,281,806 issued to McMullen on Aug. 4, 1981 shows a fishing leader storage wheel. McCullens”s invention is unlike the present invention because it requires rotation of the storage wheel to pull in the line, it does not have teeth to attach it to the fishing rod, it will not snap onto a fishing pole, and it cannot hold a line with lures.

U.S. Pat. No. 4,680,886 issued to Caselli, Sr., on Jul. 21, 1987 shows a Leadered Fishing Lure Holder with Means for Receiving Leader and Hooks. Caselli”s invention is unlike the present invention because it does not have legs to attach the holder to a fishing rod, and it has hole leads that the line must be looped through to lead the line.

U.S. Pat. No. 4, 730, 409 issued to Mitchell, et al. on Mar. 15, 1988, shows a Fishing Line Apparatus. Mitchell”s invention is unlike the present invention because it does not have grooved members to keep the line from tangling upon wrapping, or to allow the user to easily unwrap the line while in use. U.S. Design Pat. No. 335,216 issued to Carlson on May 4, 1993 shows a leader holder. Carlson”s invention is unlike the present invention because it has no attachment means to attach to a fishing pole, and it has no portion to hold lures and hooks so they do not become entangled in the line.

U.S. Pat. Nos. 2,594,472, 2,936,963 and D284, 299 show fishing leader holders as well, but none has an attachment for attaching the leader to a fishing pole, and none has a grooved member portion as does the present invention to keep the line from tangling.

Therefore a need has been established for a fishing line holder that can be easily attached and detached from a fishing rod and has a grooved means for reeling the line to prevent entanglement as well as hook and lure holders, and is easily stored in a tackle box.

### SUMMARY OF INVENTION

The present invention is a line wrap apparatus to be used when trolling. It attaches in a secure yet removable manner to a fishing pole. It is constructed of a durable, lightweight plastic and may be any color or texture. In one rendition it is a bright orange color so it may be found easily in the dark. Other renditions of the invention may be made in other colors, multiple colors and multiple textures. The present invention has two sets of legs that snap on to the fishing pole, and are attached to a flat plane that is oblong in shape. Said legs are staggered along the plane to allow the invention to be attached to varying fishing pole thicknesses, to provide additional stability and to allow the mold to be made in a less expensive manner.

There are bars attached to the oblong plane that are largest toward the center of the invention, and then decrease in size toward the curved end of the plane. This creates a curvature upon which to wrap the line and which does not rub or cut the line. The bars allow the user to neatly wind the line in such a manner that it will not become entangled. An additional advantage of this construction is that the bars provide a space for a hook, or lures to be lodged. The suggested bright orange color allows the user to easily spot the present invention. The present invention can also be manufactured in other bright colors such as green or yellow, to allow for choice in color as well as easy visibility.

An additional plane is disposed opposite the first plane and is of the same size and shape as the first plane. The two planes are parallel to each other on opposite sides of the bars. The planes and bars together create a system that the user can wrap the line around for storage purposes. Further a user may use multiple copies of the device to store different leaders designed for different fishing experiences or purposes.

### BRIEF DESCRIPTION OF DRAWINGS

FIG. 1 shows a front view of the present invention.

FIG. 2 shows a top view of the present invention.

### DETAILED DESCRIPTION

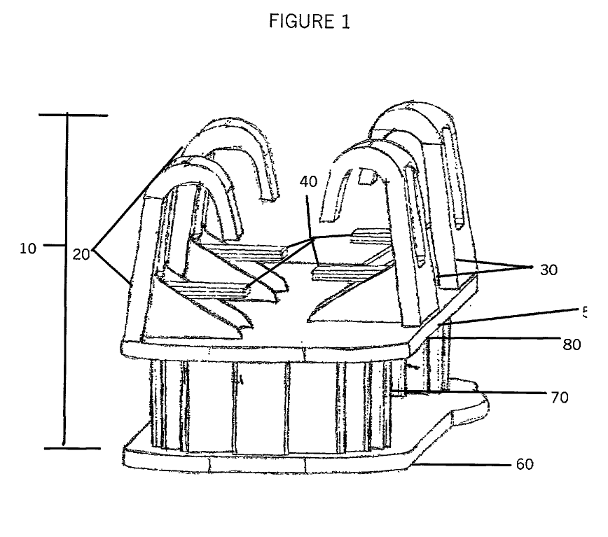

The present invention is a leader wrap apparatus to be used in the sport trolling and for fishing line storage. The present invention (10) has two pairs of legs (20,30) with fasteners (40) situated on a first plane (50). Under the first plane (50) are two sets of bars (70,80) and connecting to the second plane (60). The present invention (10) is constructed of a durable plastic, and although the current rendition of the invention has been manufactured in a bright orange color it could be made in any color or texture. The present invention allows the user to wrap the trolling line around the two sets of bars (70, 80) to prevent entanglement of the trolling line with the separate fishing line. As is shown in FIG. 1, the present invention has a first (20) and second (30) pair of legs to attach it to a conventional fishing pole. Although in this embodiment the first and second pair of legs (20, 30) are designed to fit on a pole of ½ to ¾ inches in diameter, the present invention can be manufactured in various sizes to fit poles of deviant diameters from the range above. The first (20) and second (30) pairs of legs are situated parallel to each other on top of the first plane (50). First (20) and second (30) pairs of legs have as embodiments fasteners (40) at their respective bases. The fasteners (40) allow the user the first (20) and second (30) pairs of legs around the pole (not shown). The fasteners (40) allow the user to place the present invention on the pole in a manner most comfortable to their fishing needs, on the top, sides or bottom of the pole. Although it is most advantageous for the user to place the fasteners (40) along the top side of a pole, the present invention can be fastened on any side of the pole (not shown). The first (20) and second (30) pairs of legs bend toward the center of the first plane (50) upon depression of their respective fasteners (40) to create a secure yet removable hold on the pole (not shown).

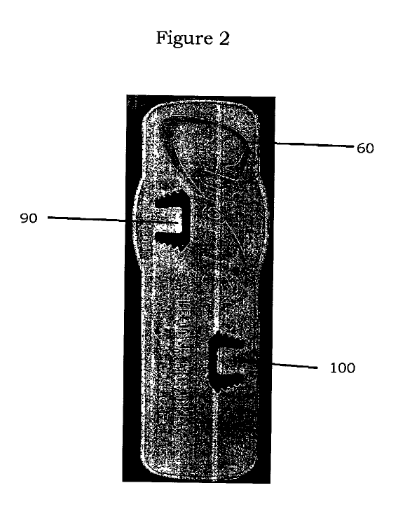

The first plane (50) is disposed parallel to the second plane (60). The first plane (50) and second plane (60) are each 5 inches long, by 1 inch wide. The total thickness of the present invention is 1 inch. The compact size of the present invention allows the user to easily store a line wrapped neatly in a tackle box. In the interim of first (50) and second (60) planes are first (70) and second (80) set of parallel bars. The first (70) and second (80) set of bars are constructed equidistant from one another in each set. The innermost bar in each set of bars (70,80) is the longest and each bar is slightly smaller to the end, creating a curvature. The curvature of the sets of bars (40) creates easy wrapping of the line upon reel in such a manner so the line will not be cut, rubbed or become tangled. The space between the bars (40) is designed to be able to accept a hook once the leader string has been fully wrapped. The currently used bright orange color of the present invention (10) makes it simple for the user to locate the present invention (10). Two horse shoe shaped cuts (FIG. 2, 90, 100) have been made on opposite sides and ends of the invention (10) which are designed to accept and secure the leader string or hook for storage purposes.

FIG. 2 shows a top view of the present invention. The second plane (60) is shown with first and second horse shoe shaped slits (90, 100). The first and second horse shoe slits (90, 100) allow the user to wrap the ends of a fishing line or loops of a line, around the horse shoe slits (90, 100) for added security for holding the line. The horse shoe slits (90, 100) allow the user to place the end of a line, with or without a lure or hook in a secure position, so the line does not unravel while in storage or in use. The horse shoe slits (90, 100) allow the user to secure the ends of a line to prevent entanglement while in storage as in a tackle box. In separate embodiments of the present invention (10) larger versions can be constructed to loop rope or larger threads for other uses such as cable storage.

The present invention is not limited to the embodiments described above and may be fashioned in any manner which accomplishes the purpose of a device which can be easily attached to a fishing rod, which works as a leader holder, and which is inexpensive to manufacture.

The present invention encompasses any and all of the embodiments in the following claims.

1. A fishing line apparatus, comprising:
a first plane;
a set of bars, communicating with said first plane;
a series of legs, communicating with said first plane; and
a second plane, communicating with said set of bars.

2. A fishing line apparatus, as in claim 1, further comprising a second set of bars.

3. A fishing line apparatus as in claim 2, wherein said set of bars, and said second set of bars are disposed on opposite ends of said first plane and said second plane.

4. A fishing line apparatus as in claim 3, wherein said set of bars create a curvature at one end of said first plane and said second plane.

5. A fishing line apparatus as in claim 4, wherein said second set of bars create a curvature at a second end of said first plane and said second plane.

6. A fishing line apparatus as in claim 1, further comprising a series of fasteners communicating with said series of legs.

7. A fishing line apparatus, as in claim 6, wherein said series of legs, and said series of fasteners communicate with a fishing rod.

8. A fishing line apparatus as in claim 7, wherein said series of legs, and said series of fasteners removably communicate with a fishing rod.

9. A fishing line apparatus, as in claim 1, further comprising two slits at opposite ends of said second plane for further securing the fishing line.

10. An apparatus, comprising:
a first plane;
a first series of bars, communicating with said first plane;
a second series of bars, communicating with said first plane;
a series of legs, communicating with said first plane;
a series of fasteners, communicating with said series of legs; and
a second plane communicating with said first and said second series of bars.

11. An apparatus as in claim 10, further comprising indentations at opposing ends of said first plane and said second plane.

12. An apparatus as in claim 10, further comprising a hollow space between said first and said second series of bars communicating with said first and said second planes.

13. An apparatus as in claim 12, wherein said first and second series of bars create curvatures from the middle to the exterior of said first and second planes.

14. An apparatus as in claim 13, wherein a fishing line can be wrapped around said first and said second series of bars.

15. An apparatus as in claim 14, wherein a lure or a hook can be placed in said hollow space for storage.

16. An apparatus as in claim 10, wherein said series of legs, and said series of fasteners communicate with a fishing rod.

17. An apparatus as in claim 10, wherein said series of legs is a means for wrapping a fishing line for storage or use.

18. An apparatus as in claim 10, wherein said series of legs is a means for wrapping a rope or thread for storage or use.
